(19) United States
(12) Patent Application Publication
(10) Pub. No.: US 2010/0027560 A1
(43) Pub. Date: Feb. 4, 2010

(54) SYSTEM AND METHOD FOR SERVICE MITIGATION IN A COMMUNICATION SYSTEM

(75) Inventors: Chen-Yui Yang, Marlboro, NJ (US); Mark Hunt, Plano, TX (US); Paritosh Bajpay, Edison, NJ (US)

Correspondence Address: AT&T Legal Department - AS;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/181,980

(22) Filed: Jul. 29, 2008

(51) Int. Cl. H04L 29/04

(52) U.S. Cl. 370/468

(57) ABSTRACT

A system that incorporates teachings of the present disclosure may include, for example, a system having a controller to monitor in a communication system bandwidth utilization by CPE, detect bandwidth utilization by the CPE that exceeds a bandwidth utilization limit, reconfigure a portion of the communication system to accommodate the increase in bandwidth utilization by the CPE, and generate a mitigation plan directed to a user of the CPE to address the increased bandwidth utilization by the CPE. Other embodiments are disclosed.

### FIELD OF THE DISCLOSURE

The present disclosure relates generally to communication systems and more specifically to a system and method for service mitigation in a communication system.

### BACKGROUND

It is common for users of communication resources such as telephony, media communications such television and audio programs, Intranet and/or Internet data services to purchase these services from a service provider with an expected bandwidth capacity. The service provider generally provisions network elements of a communication system to support an agreed bandwidth capacity for each customer. When customer premises equipment of a subscriber exceeds the bandwidth capacity agreed to between the service provider and the subscriber, the network elements can discard data packets thereby causing a potential service interruption.

### BRIEF DESCRIPTION OF THE DRAWINGS

FIGS. 1-5 depict illustrative embodiments of communication systems that provide communication services;

FIG. 6 depicts an illustrative embodiment of a portal interacting with at least one among the communication systems of FIGS. 1-4;

FIG. 7 depicts an illustrative method operating in portions of the communication systems of FIGS. 1-5; and

FIG. 8 is a diagrammatic representation of a machine in the form of a computer system within which a set of instructions, when executed, may cause the machine to perform any one or more of the methodologies discussed herein.

### DETAILED DESCRIPTION

One embodiment of the present disclosure entails a method in a communication system involving establishing a bandwidth utilization limit for customer premises equipment (CPE) utilizing communication resources of the communication system, monitoring in the communication system bandwidth utilization by the CPE, detecting bandwidth utilization by the CPE that exceeds the bandwidth utilization limit, reconfiguring one or more network elements of the communication system to temporarily accommodate the increase in bandwidth utilization by the CPE, and notifying a user of the CPE of the temporary accommodation in additional bandwidth and proposing a purchase of additional bandwidth of the communication system to adjust the bandwidth utilization limit to support at least a portion of the increased bandwidth utilization by the CPE.

Another embodiment of the present disclosure entails a computer-readable storage medium having computer instructions for monitoring in a communication system bandwidth utilization by CPE, detecting bandwidth utilization by the CPE that exceeds a bandwidth utilization limit established in a service level agreement associated with the CPE, reconfiguring one or more network elements of the communication system to accommodate the increase in bandwidth utilization by the CPE, and notifying a user of the CPE of the accommodation in additional bandwidth and proposing a mitigation plan to address the increased bandwidth utilization by the CPE.

Yet another embodiment of the present disclosure entails system having a controller to monitor in a communication system bandwidth utilization by CPE, detect bandwidth utilization by the CPE that exceeds a bandwidth utilization limit, reconfigure a portion of the communication system to accommodate the increase in bandwidth utilization by the CPE, and generate a mitigation plan directed to a user of the CPE to address the increased bandwidth utilization by the CPE.

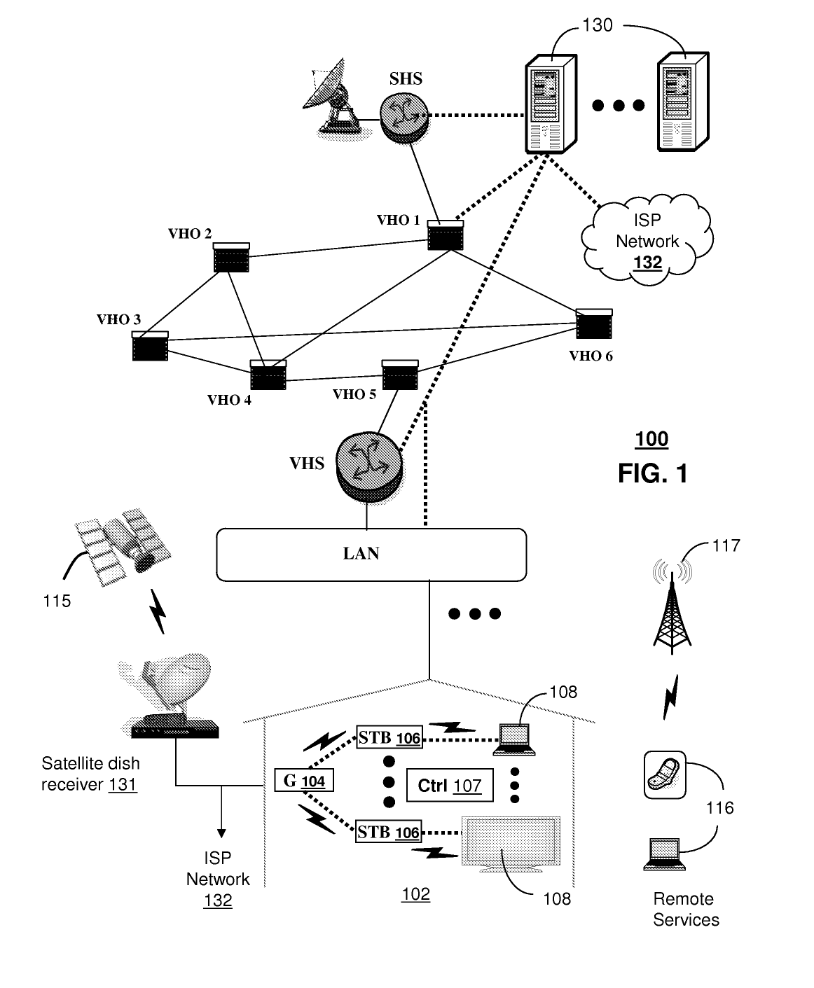

FIG. 1 depicts an illustrative embodiment of a first communication system 100 for delivering media content. The communication system 100 can represent an Internet Protocol Television (IPTV) broadcast media system. In a typical IPTV infrastructure, there is a super head-end office (SHO) with at least one super headend office server (SHS) which receives national media programs from satellite and/or media servers from service providers of multimedia broadcast channels. In the present context, media programs can represent audio content, moving image content such as videos, still image content, and/or combinations thereof. The SHS server forwards IP packets associated with the media content to video head-end servers (VHS) via a network of aggregation points such as video head-end offices (VHO) according to a common multicast communication method.

The VHS then distributes multimedia broadcast programs via a local area network (LAN) to commercial and/or residential buildings 102 housing a gateway 104 (e.g., a residential gateway or RG). The LAN can represent a bank of digital subscriber line access multiplexers (DSLAMs) located in a central office or a service area interface that provide broadband services over optical links or copper twisted pairs to buildings 102. The gateway 104 distributes broadcast signals to media processors 106 such as Set-Top Boxes (STBs) which in turn present broadcast selections to media devices 108 such as computers or television sets managed in some instances by a media controller 107 (e.g., an infrared or RF remote control).

Unicast traffic can also be exchanged between the media processors 106 and subsystems of the IPTV media system for services such as video-on-demand (VoD). It will be appreciated by one of ordinary skill in the art that the media devices 108 and/or portable communication devices 116 shown in FIG. 1 can be an integral part of the media processor 106 and can be communicatively coupled to the gateway 104. In this particular embodiment, an integral device such as described can receive, respond, process and present multicast or unicast media content.

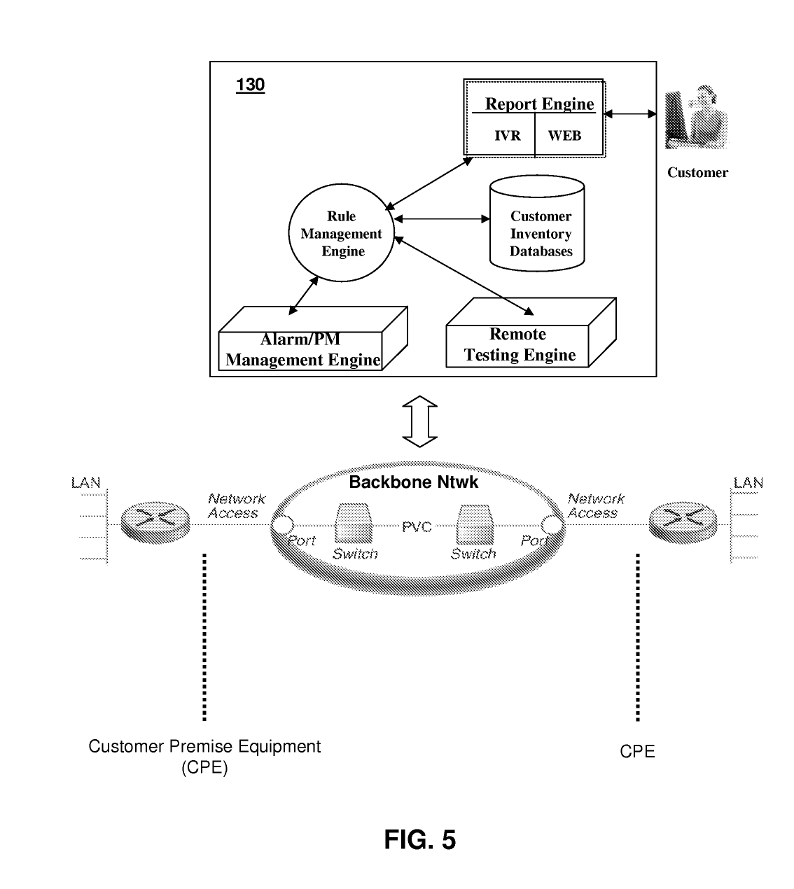

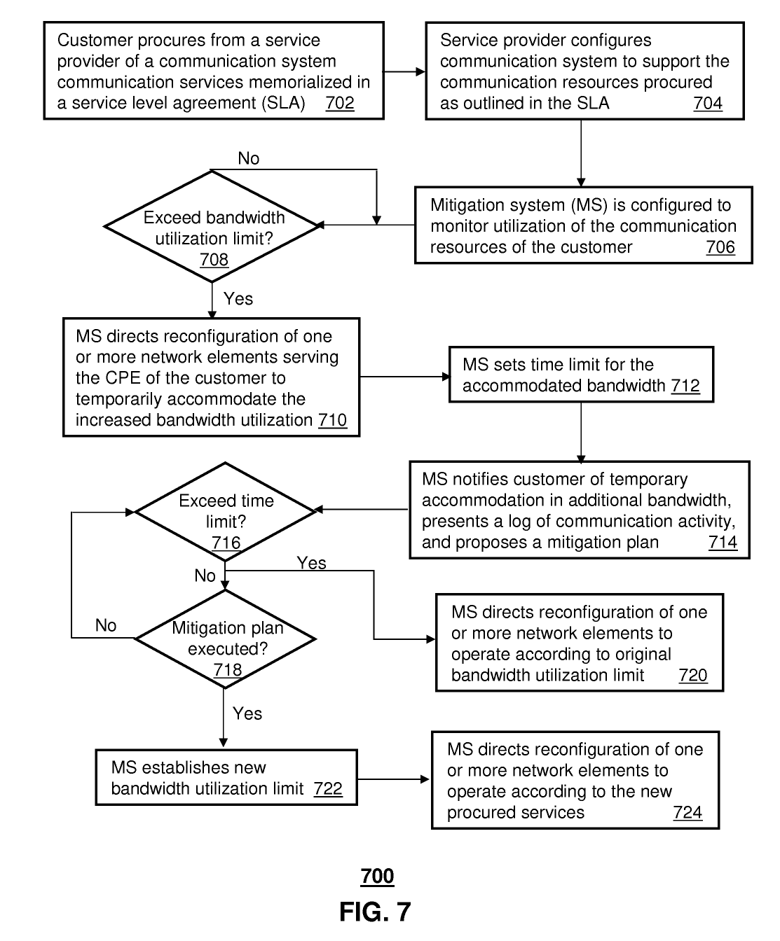

The IPTV media system can be coupled to one or more computing devices 130 a portion of which can operate as a web server for providing portal services over an Internet Service Provider (ISP) network 132 to fixed line media devices 108 or portable communication devices 116 by way of a wireless access point 117 providing Wireless Fidelity or WiFi services, or cellular communication services (e.g., GSM, CDMA, UMTS, WiMAX, etc.). Another distinct portion of the one or more computing devices 130 can be used as a mitigation system 130 for mitigating an overdraft of communication resources by customer premises equipment such as STBs requesting resources of the IPTV network, one or more computers requesting resources of the ISP network, and so on. The mitigation method proposed is described in FIG. 7 below, which is illustratively supported by FIG. 5.

A satellite broadcast television system can be used in place of the IPTV media system. In this embodiment, signals transmitted by a satellite 115 can be intercepted by a satellite dish receiver 131 coupled to building 102 which conveys media signals to the media processors 106. The media receivers 106 can be equipped with a broadband port to the ISP network 132. Although not shown, the communication system 100 can also be combined or replaced with analog or digital broadcast distributions systems such as cable TV systems.

It should be further noted that the bandwidth allocated from the DSLAMs to the gateway 104 can depend on the services procured by the customer. For example, some customers may decide to purchase standard digital subscriber line (DSL) service that provides enough bandwidth to view HD channels of the IPTV system while sharing the same bandwidth with Internet traffic over the ISP network 132. In cases where the IPTV and ISP resources consumed exceeds the bandwidth procured, service interruption or degradation can result, which can be mitigated by the mitigation system 130 as will be described below.

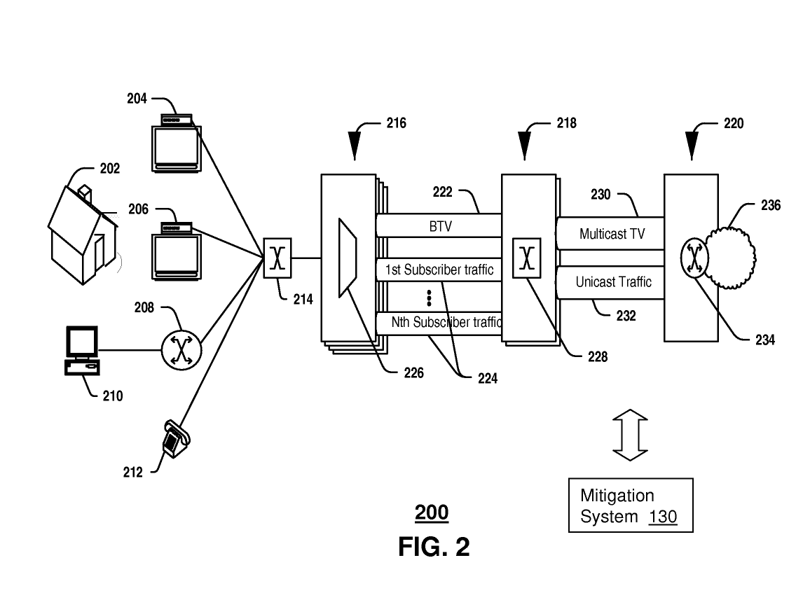

FIG. 2 depicts an illustrative embodiment of a second communication system 200 for delivering media content. Communication system 200 can be overlaid or operably coupled with communication system 100 as another representative embodiment of said communication system. The system 200 includes a distribution switch/router system 228 at a central office 218. The distribution switch/router system 228 receives video data via a multicast television stream 230 from a second distribution switch/router 234 at an intermediate office 220. The multicast television stream 230 includes Internet Protocol (IP) data packets addressed to a multicast IP address associated with a television channel. The distribution switch/router system 228 can cache data associated with each television channel received from the intermediate office 220.

The distribution switch/router system 228 also receives unicast data traffic from the intermediate office 220 via a unicast traffic stream 232. The unicast traffic stream 232 includes data packets related to devices located at a particular residence, such as the residence 202. For example, the unicast traffic stream 232 can include data traffic related to a digital subscriber line, a telephone line, another data connection, or any combination thereof. To illustrate, the unicast traffic stream 232 can communicate data packets to and from a telephone 212 associated with a subscriber at the residence 202. The telephone 212 can be a Voice over Internet Protocol (VoIP) telephone. To further illustrate, the unicast traffic stream 232 can communicate data packets to and from a personal computer 210 at the residence 202 via one or more data routers 208. In an additional illustration, the unicast traffic stream 232 can communicate data packets to and from a set-top box device, such as the set-top box devices 204, 206. The unicast traffic stream 232 can communicate data packets to and from the devices located at the residence 202 via one or more residential gateways 214 associated with the residence 202.

The distribution switch/router system 228 can send data to one or more access switch/router systems 226. The access switch/router system 226 can include or be included within a service area interface 216. In a particular embodiment, the access switch/router system 226 can include a DSLAM. The access switch/router system 226 can receive data from the distribution switch/router system 228 via a broadcast television (BTV) stream 222 and a plurality of unicast subscriber traffic streams 224. The BTV stream 222 can be used to communicate video data packets associated with a multicast stream.

For example, the BTV stream 222 can include a multicast virtual local area network (VLAN) connection between the distribution switch/router system 228 and the access switch/router system 226. Each of the plurality of subscriber traffic streams 224 can be used to communicate subscriber specific data packets. For example, the first subscriber traffic stream can communicate data related to a first subscriber, and the nth subscriber traffic stream can communicate data related to an nth subscriber. Each subscriber to the system 200 can be associated with a respective subscriber traffic stream 224. The subscriber traffic stream 224 can include a subscriber VLAN connection between the distribution switch/router system 228 and the access switch/router system 226 that is associated with a particular set-top box device 204, 206, a particular residence 202, a particular residential gateway 214, another device associated with a subscriber, or any combination thereof.

In an illustrative embodiment, a set-top box device, such as the set-top box device 204, receives a channel change command from an input device, such as a remoter control device. The channel change command can indicate selection of an IPTV channel. After receiving the channel change command, the set-top box device 204 generates channel selection data that indicates the selection of the IPTV channel. The set-top box device 204 can send the channel selection data to the access switch/router system 226 via the residential gateway 214. The channel selection data can include an Internet Group Management Protocol (IGMP) Join request. In an illustrative embodiment, the access switch/router system 226 can identify whether it is joined to a multicast group associated with the requested channel based on information in the IGMP Join request.

If the access switch/router system 226 is not joined to the multicast group associated with the requested channel, the access switch/router system 226 can generate a multicast stream request. The multicast stream request can be generated by modifying the received channel selection data. In an illustrative embodiment, the access switch/router system 226 can modify an IGMP Join request to produce a proxy IGMP Join request. The access switch/router system 226 can send the multicast stream request to the distribution switch/router system 228 via the BTV stream 222. In response to receiving the multicast stream request, the distribution switch/router system 228 can send a stream associated with the requested channel to the access switch/router system 226 via the BTV stream 222.

The mitigation system 130 of FIG. 1 can be operably coupled to the second communication system 200 for purposes similar to those described above.

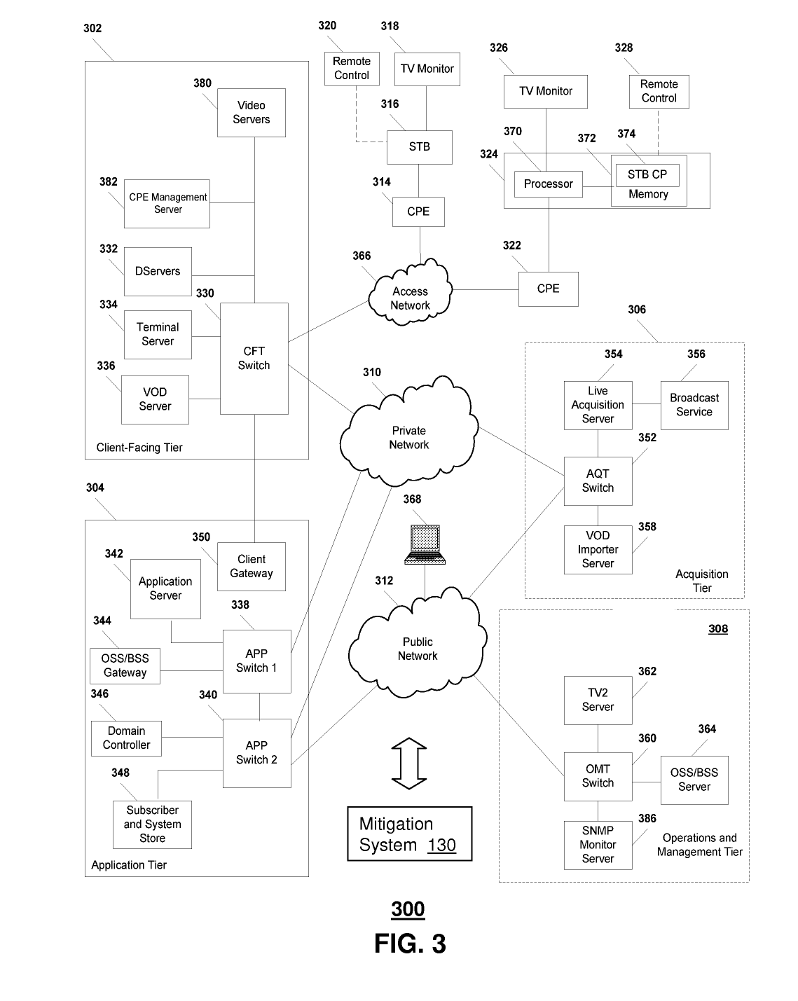

FIG. 3 depicts an illustrative embodiment of a third communication system 300 for delivering media content. Communication system 300 can be overlaid or operably coupled with communication systems 100-200 as another representative embodiment of said communication systems. As shown, the system 300 can include a client facing tier 302, an application tier 304, an acquisition tier 306, and an operations and management tier 308. Each tier 302, 304, 306, 308 is coupled to a private network 310, such as a network of common packet-switched routers and/or switches; to a public network 312, such as the Internet; or to both the private network 310 and the public network 312. For example, the client-facing tier 302 can be coupled to the private network 310. Further, the application tier 304 can be coupled to the private network 310 and to the public network 312. The acquisition tier 306 can also be coupled to the private network 310 and to the public network 312. Additionally, the operations and management tier 308 can be coupled to the public network 312.

As illustrated in FIG. 3, the various tiers 302, 304, 306, 308 communicate with each other via the private network 310 and the public network 312. For instance, the client-facing tier 302 can communicate with the application tier 304 and the acquisition tier 306 via the private network 310. The application tier 304 can communicate with the acquisition tier 306 via the private network 310. Further, the application tier 304 can communicate with the acquisition tier 306 and the operations and management tier 308 via the public network 312. Moreover, the acquisition tier 306 can communicate with the operations and management tier 308 via the public network 312. In a particular embodiment, elements of the application tier 304, including, but not limited to, a client gateway 350, can communicate directly with the client-facing tier 302.

The client-facing tier 302 can communicate with user equipment via an access network 366, such as an IPTV access network. In an illustrative embodiment, customer premises equipment (CPE) 314, 322 can be coupled to a local switch, router, or other device of the access network 366. The client-facing tier 302 can communicate with a first representative set-top box device 316 via the first CPE 314 and with a second representative set-top box device 324 via the second CPE 322. In a particular embodiment, the first representative set-top box device 316 and the first CPE 314 can be located at a first customer premise, and the second representative set-top box device 324 and the second CPE 322 can be located at a second customer premise.

In another particular embodiment, the first representative set-top box device 316 and the second representative set-top box device 324 can be located at a single customer premise, both coupled to one of the CPE 314, 322. The CPE 314, 322 can include routers, local area network devices, modems, such as digital subscriber line (DSL) modems, any other suitable devices for facilitating communication between a set-top box device and the access network 366, or any combination thereof.

In an illustrative embodiment, the client-facing tier 302 can be coupled to the CPE 314, 322 via fiber optic cables. In another illustrative embodiment, the CPE 314, 322 can include DSL modems that are coupled to one or more network nodes via twisted pairs, and the client-facing tier 302 can be coupled to the network nodes via fiber-optic cables. Each set-top box device 316, 324 can process data received via the access network 366, via a common IPTV software platform.

The first set-top box device 316 can be coupled to a first external display device, such as a first television monitor 318, and the second set-top box device 324 can be coupled to a second external display device, such as a second television monitor 326. Moreover, the first set-top box device 316 can communicate with a first remote control 320, and the second set-top box device 324 can communicate with a second remote control 328. The set-top box devices 316, 324 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an illustrative, non-limiting embodiment, each set-top box device 316, 324 can receive data, video, or any combination thereof, from the client-facing tier 302 via the access network 366 and render or display the data, video, or any combination thereof, at the display device 318, 326 to which it is coupled. In an illustrative embodiment, the set-top box devices 316, 324 can include tuners that receive and decode television programming signals or packet streams for transmission to the display devices 318, 326. Further, the set-top box devices 316, 324 can each include a STB processor 370 and a STB memory device 372 that is accessible to the STB processor 370. In one embodiment, a computer program, such as the STB computer program 374, can be embedded within the STB memory device 372.

In an illustrative embodiment, the client-facing tier 302 can include a client-facing tier (CFT) switch 330 that manages communication between the client-facing tier 302 and the access network 366 and between the client-facing tier 302 and the private network 310. As illustrated, the CFT switch 330 is coupled to one or more distribution servers, such as Distribution-servers (D-servers) 332, that store, format, encode, replicate, or otherwise manipulate or prepare video content for communication from the client-facing tier 302 to the set-top box devices 316, 324. The CFT switch 330 can also be coupled to a terminal server 334 that provides terminal devices with a point of connection to the IPTV system 300 via the client-facing tier 302.

In a particular embodiment, the CFT switch 330 can be coupled to a VoD server 336 that stores or provides VoD content imported by the IPTV system 300. Further, the CFT switch 330 is coupled to one or more video servers 380 that receive video content and transmit the content to the set-top boxes 316, 324 via the access network 366. The client-facing tier 302 may include a CPE management server 382 that manages communications to and from the CPE 314 and the CPE 322. For example, the CPE management server 382 may collect performance data associated with the set-top box devices 316, 324 from the CPE 314 or the CPE 322 and forward the collected performance data to a server associated with the operations and management tier 308.

In an illustrative embodiment, the client-facing tier 302 can communicate with a large number of set-top boxes, such as the representative set-top boxes 316, 324, over a wide geographic area, such as a metropolitan area, a viewing area, a statewide area, a regional area, a nationwide area or any other suitable geographic area, market area, or subscriber or customer group that can be supported by networking the client-facing tier 302 to numerous set-top box devices. In a particular embodiment, the CFT switch 330, or any portion thereof, can include a multicast router or switch that communicates with multiple set-top box devices via a multicast-enabled network.

As illustrated in FIG. 3, the application tier 304 can communicate with both the private network 310 and the public network 312. The application tier 304 can include a first application tier (APP) switch 338 and a second APP switch 340. In a particular embodiment, the first APP switch 338 can be coupled to the second APP switch 340. The first APP switch 338 can be coupled to an application server 342 and to an OSS/BSS gateway 344. In a particular embodiment, the application server 342 can provide applications to the set-top box devices 316, 324 via the access network 366, which enable the set-top box devices 316, 324 to provide functions, such as interactive program guides, video gaming, display, messaging, processing of VoD material and other IPTV content, etc. In an illustrative embodiment, the application server 342 can provide location information to the set-top box devices 316, 324. In a particular embodiment, the OSS/BSS gateway 344 includes operation systems and support (OSS) data, as well as billing systems and support (BSS) data. In one embodiment, the OSS/BSS gateway 344 can provide or restrict access to an OSS/BSS server 364 that stores operations and billing systems data.

The second APP switch 340 can be coupled to a domain controller 346 that provides Internet access, for example, to users at their computers 368 via the public network 312. For example, the domain controller 346 can provide remote Internet access to IPTV account information, e-mail, personalized Internet services, or other online services via the public network 312. In addition, the second APP switch 340 can be coupled to a subscriber and system store 348 that includes account information, such as account information that is associated with users who access the IPTV system 300 via the private network 310 or the public network 312. In an illustrative embodiment, the subscriber and system store 348 can store subscriber or customer data and create subscriber or customer profiles that are associated with IP addresses, stock-keeping unit (SKU) numbers, other identifiers, or any combination thereof, of corresponding set-top box devices 316, 324. In another illustrative embodiment, the subscriber and system store can store data associated with capabilities of set-top box devices associated with particular customers.

In a particular embodiment, the application tier 304 can include a client gateway 350 that communicates data directly to the client-facing tier 302. In this embodiment, the client gateway 350 can be coupled directly to the CFT switch 330. The client gateway 350 can provide user access to the private network 310 and the tiers coupled thereto. In an illustrative embodiment, the set-top box devices 316, 324 can access the IPTV system 300 via the access network 366, using information received from the client gateway 350. User devices can access the client gateway 350 via the access network 366, and the client gateway 350 can allow such devices to access the private network 310 once the devices are authenticated or verified. Similarly, the client gateway 350 can prevent unauthorized devices, such as hacker computers or stolen set-top box devices from accessing the private network 310, by denying access to these devices beyond the access network 366.

For example, when the first representative set-top box device 316 accesses the client-facing tier 302 via the access network 366, the client gateway 350 can verify subscriber information by communicating with the subscriber and system store 348 via the private network 310. Further, the client gateway 350 can verify billing information and status by communicating with the OSS/BSS gateway 344 via the private network 310. In one embodiment, the OSS/BSS gateway 344 can transmit a query via the public network 312 to the OSS/BSS server 364. After the client gateway 350 confirms subscriber and/or billing information, the client gateway 350 can allow the set-top box device 316 to access IPTV content and VoD content at the client-facing tier 302. If the client gateway 350 cannot verify subscriber information for the set-top box device 316, e.g., because it is connected to an unauthorized twisted pair, the client gateway 350 can block transmissions to and from the set-top box device 316 beyond the access network 366.

As indicated in FIG. 3, the acquisition tier 306 includes an acquisition tier (AQT) switch 352 that communicates with the private network 310. The AQT switch 352 can also communicate with the operations and management tier 308 via the public network 312. In a particular embodiment, the AQT switch 352 can be coupled to one or more live Acquisition-servers (A-servers) 354 that receive or acquire television content, movie content, advertisement content, other video content, or any combination thereof, from a broadcast service 356, such as a satellite acquisition system or satellite head-end office. In a particular embodiment, the live acquisition server 354 can transmit content to the AQT switch 352, and the AQT switch 352 can transmit the content to the CFT switch 330 via the private network 310.

In an illustrative embodiment, content can be transmitted to the D-servers 332, where it can be encoded, formatted, stored, replicated, or otherwise manipulated and prepared for communication from the video server(s) 380 to the set-top box devices 316, 324. The CFT switch 330 can receive content from the video server(s) 380 and communicate the content to the CPE 314, 322 via the access network 366. The set-top box devices 316, 324 can receive the content via the CPE 314, 322, and can transmit the content to the television monitors 318, 326. In an illustrative embodiment, video or audio portions of the content can be streamed to the set-top box devices 316, 324.

Further, the AQT switch 352 can be coupled to a video-on-demand importer server 358 that receives and stores television or movie content received at the acquisition tier 306 and communicates the stored content to the VoD server 336 at the client-facing tier 302 via the private network 310. Additionally, at the acquisition tier 306, the VoD importer server 358 can receive content from one or more VoD sources outside the IPTV system 300, such as movie studios and programmers of non-live content. The VoD importer server 358 can transmit the VoD content to the AQT switch 352, and the AQT switch 352, in turn, can communicate the material to the CFT switch 330 via the private network 310. The VoD content can be stored at one or more servers, such as the VoD server 336.

When users issue requests for VoD content via the set-top box devices 316, 324, the requests can be transmitted over the access network 366 to the VoD server 336, via the CFT switch 330. Upon receiving such requests, the VoD server 336 can retrieve the requested VoD content and transmit the content to the set-top box devices 316, 324 across the access network 366, via the CFT switch 330. The set-top box devices 316, 324 can transmit the VoD content to the television monitors 318, 326. In an illustrative embodiment, video or audio portions of VoD content can be streamed to the set-top box devices 316, 324.

FIG. 3 further illustrates that the operations and management tier 308 can include an operations and management tier (OMT) switch 360 that conducts communication between the operations and management tier 308 and the public network 312. In the embodiment illustrated by FIG. 3, the OMT switch 360 is coupled to a TV2 server 362. Additionally, the OMT switch 360 can be coupled to an OSS/BSS server 364 and to a simple network management protocol monitor 386 that monitors network devices within or coupled to the IPTV system 300. In a particular embodiment, the OMT switch 360 can communicate with the AQT switch 352 via the public network 312.

The OSS/BSS server 364 may include a cluster of servers, such as one or more CPE data collection servers that are adapted to request and store operations systems data, such as performance data from the set-top box devices 316, 324. In an illustrative embodiment, the CPE data collection servers may be adapted to analyze performance data to identify a condition of a physical component of a network path associated with a set-top box device, to predict a condition of a physical component of a network path associated with a set-top box device, or any combination thereof.

In an illustrative embodiment, the live acquisition server 354 can transmit content to the AQT switch 352, and the AQT switch 352, in turn, can transmit the content to the OMT switch 360 via the public network 312. In this embodiment, the OMT switch 360 can transmit the content to the TV2 server 362 for display to users accessing the user interface at the TV2 server 362. For example, a user can access the TV2 server 362 using a personal computer 368 coupled to the public network 312.

The mitigation system 130 of FIG. 1 can be operably coupled to the third communication system 300 for purposes similar to those described above.

It should be apparent to one of ordinary skill in the art from the foregoing media communication system embodiments that other suitable media communication systems for distributing broadcast media content as well as peer-to-peer exchange of content can be applied to the present disclosure.

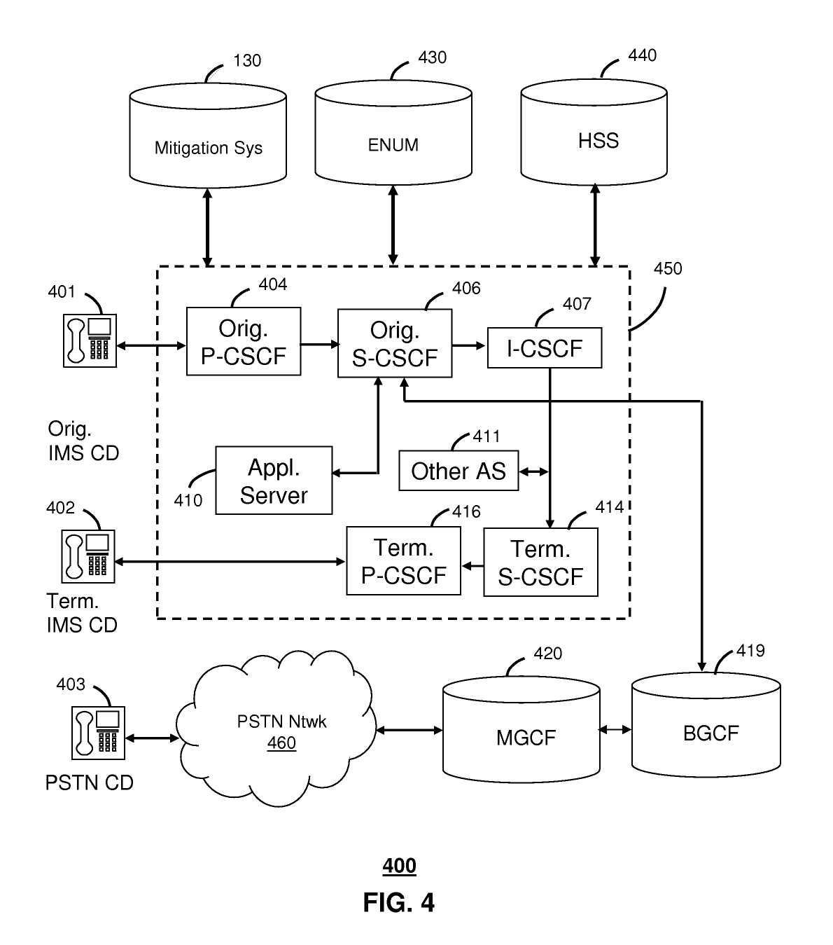

FIG. 4 depicts an illustrative embodiment of a communication system 400 employing an IP Multimedia Subsystem (IMS) network architecture. Communication system 400 can be overlaid or operably coupled with communication systems 100-300 as another representative embodiment of said communication systems.

The communication system 400 can comprise a Home Subscriber Server (HSS) 440, a tElephone NUmber Mapping (ENUM) server 430, and network elements of an IMS network 450. The IMS network 450 can be coupled to IMS compliant communication devices (CD) 401, 402 or a Public Switched Telephone Network (PSTN) CD 403 using a Media Gateway Control Function (MGCF) 420 that connects the call through a common PSTN network 460.

IMS CDs 401, 402 register with the IMS network 450 by contacting a Proxy Call Session Control Function (P-CSCF) which communicates with a corresponding Serving CSCF (S-CSCF) to register the CDs with an Authentication, Authorization and Accounting (AAA) supported by the HSS 440. To accomplish a communication session between CDs, an originating IMS CD 401 can submit a Session Initiation Protocol (SIP INVITE) message to an originating P-CSCF 404 which communicates with a corresponding originating S-CSCF 406. The originating S-CSCF 406 can submit the SIP INVITE message to an application server (AS) such as reference 410 that can provide a variety of services to IMS subscribers. For example, the application server 410 can be used to perform originating treatment functions on the calling party number received by the originating S-CSCF 406 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating S-CSCF 406 can submit queries to the ENUM system 430 to translate an E.164 telephone number to a SIP Uniform Resource Identifier (URI) if the targeted communication device is IMS compliant. If the targeted communication device is a PSTN device, the ENUM system 430 will respond with an unsuccessful address resolution and the S-CSCF 406 will forward the call to the MGCF 420 via a Breakout Gateway Control Function (BGCF) 419.

When the ENUM server 430 returns a SIP URI, the SIP URI is used by an Interrogating CSCF (I-CSCF) 407 to submit a query to the HSS 440 to identify a terminating S-CSCF 414 associated with a terminating IMS CD such as reference 402. Once identified, the I-CSCF 407 can submit the SIP INVITE to the terminating S-CSCF 414 which can call on an application server 411 similar to reference 410 to perform the originating treatment telephony functions described earlier. The terminating S-CSCF 414 can then identify a terminating P-CSCF 416 associated with the terminating CD 402. The P-CSCF 416 then signals the CD 402 to establish communications. The aforementioned process is symmetrical. Accordingly, the terms “originating” and “terminating” in FIG. 4 can be interchanged.

IMS network 450 can also be operably coupled to the mitigation system 130 previously discussed for FIG. 1. In this representative embodiment, the mitigation system 130 can be accessed over a PSTN or VoIP channel of communication system 400 by common techniques such as described above.

052 In cases where a customer procures both IPTV and IMS services, the bandwidth allocated for these services may be shared between these systems. When resources of both systems exceed the bandwidth allocated, service interruptions and/or degradation can occur. The mitigation system 130 can be programmed to prevent or at least mitigate these issues as will be discussed below.

FIG. 5 depicts an illustrative embodiment of the mitigation system 130 managing a backbone network representative of any of the communication systems of FIGS. 1-4. The mitigation system 130 can comprise for example a Rule Management Engine that utilizes common computing technology to monitor network alarms, perform remote testing a the backbone network shown in FIG. 5, and report mitigation results to a customer. Alarm monitoring, remote testing and reporting can be performed by way of an alarm program management engine, a remote testing engine, and a reporting engine each of which can utilize common computing and communications technology to access the network elements of the backbone and the customer premises equipment (CPE). The reporting engine can interface with a customer by way of an interactive voice response system (IVR), a web server, or other suitable wireless or wireline communication mediums (e.g., SMS, MMS, email, paging, etc.). The elements of the mitigation system 130 can be centralized or decentralized computing elements of the communication systems 100-400.

The backbone network of FIG. 5 can comprise common packet-switching elements such as routers, asynchronous transfer mode (or ATM) elements, frame relay elements, and so on, each of which provide communication services to the CPE. The backbone network can also be configured as a Multi-Protocol Label Switching (MPLS) network for transporting data traffic between end points. For enterprise customers who request private network resources, private virtual circuits (PVCs) can be configured by way of the network elements of the backbone network between sites of an enterprise customer. Each of the PVCs can be configured for a bandwidth utilization limit that can be memorialized in a service level agreement (SLA) with the service provider of the backbone network. The SLA and related customer data can be stored and periodically retrieved from customer inventory databases of the mitigation system 130 shown in FIG. 5.

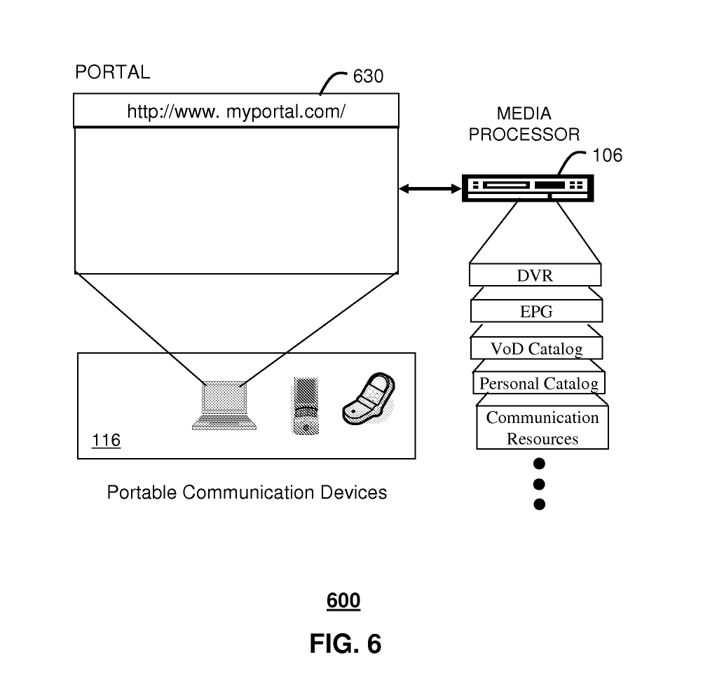

FIG. 6 depicts an illustrative embodiment of a portal 630. The portal 630 can be used by a customer for managing and procuring resources of communication systems 100-500. The portal 630 can be accessed by a Uniform Resource Locator (URL) with a common Internet browser such as Microsoft's Internet Explorer using an Internet-capable communication device such as references 108, 116, or 210 of FIGS. 1-2. The portal 630 can be configured to access a media processor such as references 106, 204, 206, 316, and 324 of FIGS. 1-3 and services managed thereby such as a Digital Video Recorder (DVR), an Electronic Programming Guide (EPG), VoD catalog, a personal catalog stored in the STB (e.g., personal videos, pictures, audio recordings, etc.), procure or update subscription to communication resources, and so on.

FIG. 7 depicts illustrative embodiments of method 700 operating in portions of communication systems 100-500. Method 700 can begin with step 702 in which a customer procures communication services from a service provider of the communication systems of FIGS. 1-5. In this step the customer can select which services are requested (IPTV, Internet, Intranet, one or more PVCs, or combinations thereof) which can be memorialized in a service level agreement (SLA). The SLA can further include operating parameters that define the operational limits of the communication resources supplied by the service provider. Operating parameters can include for instance Quality of Service (QoS) requirements, reliability of service requirements, and/or a bandwidth utilization limit which bounds the bandwidth supplied by the communication system to the CPE managed by the customer. A bandwidth utilization limit can for example be represented by a packet or bit level communication rate for upstream and downstream communications (e.g., 100 Megabits per second or Mbps for upstream communications, and 1 Gigabit per second or Gbps for downstream communications).

Once the SLA has been established, the service provider can configure portions of one or more of the communication systems 100-500 in step 704 to support the procured services for the select customer. In step 706, the service provider can configure the mitigation system 130 to monitor in step 708 among other things the bandwidth utilization of the customer's CPE. The mitigation system 130 can perform step 708 by monitoring transmission parameters of one or more network elements of the communication system such as a provider edge router coupled to an edge of the customer's CPE such as a customer edge router. For customers with multiple CPE sites, the mitigation system 130 can be configured to also monitor intermediate network elements providing a transmission path between CPEs. In this illustrative embodiment, the transmission parameters monitored can be associated to one or more PVCs assigned between the CPEs. Transmission parameters monitored can include packet or bit rate of communication, packet losses, jitter, and latency to determine whether QoS metrics established in the SLA are satisfied.

If, for example, the mitigation system 130 determines in step 708 that bandwidth utilization by a CPE or between CPEs has exceeded the bandwidth utilization limit specified in an SLA, the mitigation system can proceed to step 710 where it directs the reconfiguration of one or more network elements serving the CPE (or CPEs) of the customer to temporarily accommodate the increased bandwidth utilization, thereby mitigating a potential interruption in services. The temporary accommodation can be accomplished by rerouting PVCs of the customer to other network elements with more capacity, routing traffic of other customers away from network elements supporting the PVCs to increase the bandwidth capacity assigned thereto, or combinations thereof. The additional bandwidth resources are set to expire according to a time limit set by the mitigation system 130 in step 712.

Responsive to these steps, the mitigation system 130 can notify in step 714 the customer of the temporary accommodation in additional bandwidth, present a log of communication activity prompting a need to accommodate the additional bandwidth, and a proposed mitigation plan. The log can include for example information that summarizes the excess in bandwidth utilization by the CPE. The information can comprise a time stamp indicating when the bandwidth utilization by the CPE exceeded the bandwidth utilization limit, a description of the CPE demanding more bandwidth, one or more traffic metrics associated with one or more network elements of the communication system serving the CPE, one or more traffic metrics associated with the CPE causing the higher demand, or combinations thereof. The mitigation plan can propose a purchase plan that supports the increase in communication resources used by the customer's CPE. The customer can effectuate the mitigation plan by calling a service agent of the communication system directly, an IVR, or by adjusting the SLA over a portal such as described in FIG. 6.

The notification can be conveyed to the customer over an IVR, a web server, email, SMS, MMS, paging, or other suitable communication means. With the information provided in the log and the mitigation plan, the customer can readily determine whether a change in the services previously procured is needed.

In steps, 716-718, the mitigation system 130 can determine if the time limit has been exceeded prior to the customer executing the mitigation plan. If the time limit is exceeded without mitigation by the customer, the mitigation system proceeds to step 720 where it directs the reconfiguration of the one or more network elements to operates according to the original bandwidth utilization limit of the SLA established in step 702. If on the other hand, the customer executes the proposed mitigation plan in whole or in part to support the accommodated resources permanently prior to the expiration of the time limit, the mitigation system 130 proceeds to step 722 where it establishes a new (higher) bandwidth utilization limit and in step 724 directs reconfiguration of one or more network elements to operate according to the new procured services. Step 724 may not be necessary if the reconfiguration process used in step 710 is equivalent to the new services procured.

Upon reviewing the aforementioned embodiments, it would be evident to an artisan with ordinary skill in the art that said embodiments can be modified, reduced, or enhanced without departing from the scope and spirit of the claims described below. For example, when mitigating high bandwidth demands for consumer services, method 700 can be adapted to automatically reconfigure a DSLAM, route traffic to another DSLAM, and/or configure active circuits at a service area interface serving the consumer's residence gateway 104 to upgrade a consumer from a standard DSL service to an advance DSL (ADSL), or a very high rate DSL (VDSL) service to accommodate the additional bandwidth required when, for example, IMS, high Internet data traffic, and high demand for IPTV services are occurring simultaneously, and the previously subscribe standard DSL services is unable to keep up with the demand for bandwidth. Thus, the present disclosure is applicable to both enterprise customers as well as mass market consumers of media services.

Other suitable modifications can be applied to the present disclosure. Accordingly, the reader is directed to the claims section for a fuller understanding of the breadth and scope of the present disclosure.

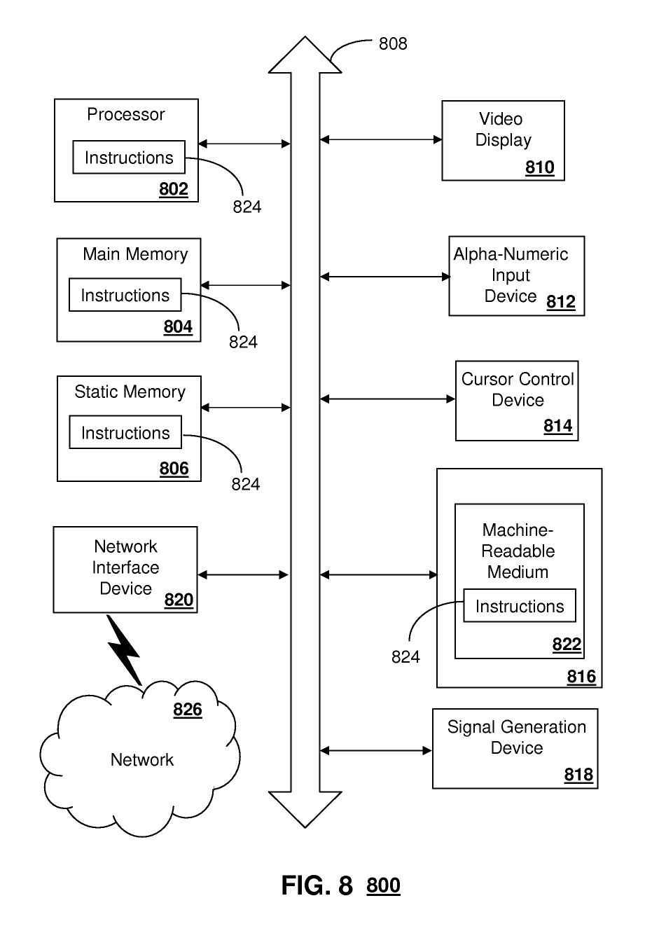

FIG. 8 depicts an illustrative diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a computer-readable medium 822 on which is stored one or more sets of instructions (e.g., software 824) embodying any one or more of the methodologies or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute computer-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the computer-readable medium 822 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a computer-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. In a communication system, a method, comprising:
establishing a bandwidth utilization limit for customer premises equipment (CPE) utilizing communication resources of the communication system;
monitoring in the communication system bandwidth utilization by the CPE;
detecting bandwidth utilization by the CPE that exceeds the bandwidth utilization limit;
reconfiguring one or more network elements of the communication system to temporarily accommodate the increase in bandwidth utilization by the CPE; and
notifying a user of the CPE of the temporary accommodation in additional bandwidth and proposing a procurement of additional bandwidth of the communication system to adjust the bandwidth utilization limit to support at least a portion of the increased bandwidth utilization by the CPE.

2. The method of claim 1, comprising establishing a time limit for accommodating the increased bandwidth utilization by the CPE.

3. The method of claim 2, comprising reconfiguring the one or more network elements of the communication system to operate according to the bandwidth utilization limit responsive to an expiration of the time limit.

4. The method of claim 2, comprising maintaining the accommodated increase in bandwidth utilization by the CPE responsive to receiving an indication that the proposed additional bandwidth has been purchased prior to an expiration of the time limit.

5. The method of claim 1, comprising maintaining the accommodated increase in bandwidth utilization by the CPE responsive to receiving an indication that the proposed additional bandwidth has been purchased.

6. The method of claim 1, comprising generating a log with information summarizing the excess in bandwidth utilization by the CPE.

7. The method of claim 6, wherein the information comprises one of a time stamp indicating when the bandwidth utilization by the CPE exceeded the bandwidth utilization limit, a description of the CPE, one or more traffic metrics associated with one or more network elements of the communication system serving the CPE, one or more traffic metrics associated with the CPE, and combinations thereof.

8. The method of claim 6, comprising including the log in the notification to the user.

9. The method of claim 1, comprising notifying the user of the CPE by way of one of an interactive voice response system, a wireless communication medium, and a wireline communication medium.

10. The method of claim 1, wherein the bandwidth utilization monitored for the CPE is associated with one or more virtual communication circuits.

11. The method of claim 10, comprising detecting a service interruption of the one or more virtual communication circuits resulting from an increase in bandwidth utilization by the CPE that exceeds the bandwidth utilization limit.

12. The method of claim 10, wherein the reconfigured one or more network elements reroute at least a portion of the one or more virtual communication circuits to accommodate the increase in bandwidth utilization by the CPE.

13. The method of claim 1, wherein the communication system supplies services to the CPE by way of a packet-switched communication network.

14. The method of claim 1, comprising reconfiguring the one or more network elements of the communication system according to a business arrangement between the user of the CPE and a service provider of the communication system memorialized in a service level agreement.

15. A computer-readable storage medium, comprising computer instructions for:
monitoring in a communication system bandwidth utilization by customer premises equipment (CPE);
detecting bandwidth utilization by the CPE that exceeds a bandwidth utilization limit established in a service level agreement associated with the CPE;
reconfiguring one or more network elements of the communication system to accommodate the increase in bandwidth utilization by the CPE; and
notifying a user of the CPE of the accommodation in additional bandwidth and proposing a mitigation plan to address the increased bandwidth utilization by the CPE.

16. The storage medium of claim 15, wherein the mitigation plan comprises proposing a plan to purchase additional bandwidth of the communication system to adjust the bandwidth utilization limit to a level that supports at least a portion of the increased bandwidth utilization by the CPE.

17. The storage medium of claim 15, comprising computer instructions for establishing a time limit for accommodating the increased bandwidth utilization by the CPE.

18. The storage medium of claim 17, comprising computer instructions for reconfiguring the one or more network elements of the communication system to operate according to the bandwidth utilization limit responsive to an expiration of the time limit.

19. The storage medium of claim 17, comprising computer instructions for maintaining the accommodated increase in bandwidth utilization by the CPE responsive to receiving an indication that at least a portion of the proposed mitigation plan has been executed by the user prior to an expiration of the time limit.

20. The storage medium of claim 15, comprising computer instructions for maintaining the accommodated increase in bandwidth utilization by the CPE responsive to receiving an indication that at least a portion of the proposed mitigation plan has been executed by the user.

21. The storage medium of claim 15, comprising computer instructions for generating a log with a description summarizing at least one of the excess in bandwidth utilization by the CPE, a time stamp indicating when the bandwidth utilization by the CPE exceeded the bandwidth utilization limit, a description of the CPE, one or more traffic metrics associated with one or more network elements of the communication system serving the CPE, one or more traffic metrics associated with the CPE, and combinations thereof.

22. The storage medium of claim 15, wherein the communication system comprises one of an Internet Protocol Television (IPTV) communication system, a cable TV communication system, a satellite TV communication system, a Internet Service Provider communication system, an IP Multimedia Subsystem communication system, or combinations thereof.

23. A system, comprising a controller to:
monitor in a communication system bandwidth utilization by customer premises equipment (CPE);
detect bandwidth utilization by the CPE that exceeds a bandwidth utilization limit;
reconfigure a portion of the communication system to accommodate the increase in bandwidth utilization by the CPE; and
generate a mitigation plan directed to a user of the CPE to address the increased bandwidth utilization by the CPE.

24. The system of claim 23, wherein the mitigation plan comprises proposing a plan to purchase additional bandwidth of the communication system to adjust the bandwidth utilization limit to a level that supports at least a portion of the increased bandwidth utilization by the CPE, and wherein the controller is adapted to notify the user of the CPE of at least one of the accommodation in additional bandwidth and the proposed mitigation plan.

25. The system of claim 23, wherein the controller is adapted to:
establish a time limit for accommodating the increased bandwidth utilization by the CPE;
reconfigure the one or more network elements of the communication system to operate according to the bandwidth utilization limit responsive to an expiration of the time limit; and
maintain the accommodated increase in bandwidth utilization by the CPE responsive to receiving an indication that at least a portion of the proposed mitigation plan has been executed by the user prior to an expiration of the time limit.
